(19) United States
(12) Patent Application Publication
(10) Pub. No.: US 2017/0104728 A1
(43) Pub. Date: Apr. 13, 2017

(54) WIRELESS NETWORK IDENTIFIER WITH ENCRYPTED NETWORK ACCESS INFORMATION

(71) Applicant: E. J. Ward, Inc., San Antonio, TX (US)

(72) Inventors: David Thayer Girard, San Antonio, TX (US); Markay Rene Ward, San Antonio, TX (US); Edward John Kotzur, San Antonio, TX (US)

(73) Assignee: E.J. Ward, Inc., San Antonio, TX (US)

(21) Appl. No.: 15/073,075

(22) Filed: Mar. 17, 2016

Related U.S. Application Data
(60) Provisional application No. 62/238,577, filed on Oct. 7, 2015.

(51) Int. Cl. H04L 29/06; H04W 12/08

(52) U.S. Cl. CPC H04L 63/0428; H04W 12/08

(57) ABSTRACT

A data acquisition platform in which self-configuring devices communicate with a database through an intermediate wireless access point. The database may store data acquired by and uploaded from self-configuring devices and store information that may be downloaded to self-configuring devices and used to self-configure. In a fleet management embodiment, self-configuring devices include OBD data capture devices installed in a motor vehicle that is part of an entity's vehicle fleet. The platform may support an auto-connect feature in which wireless network access information needed by self-configuring devices to login to a wireless LAN is encrypted and wirelessly broadcasted by the access point. The network identifier may comply with formatting protocol that enables self-configuring devices to recognize encrypted network identifiers. In WiFi embodiments, the network identifier may be an encrypted SSID or an SSID that includes unencrypted and encrypted parts.

This application claims priority to and the benefit of U.S. provisional patent application 62/238,577, filed Oct. 7, 2015, which is incorporated by reference herein, in its entirety.

### BACKGROUND

Field of Invention

Disclosed subject matter is in the field of data acquisition devices including remote data acquisition devices used in fleet management and similar applications.

Description of Related Art

Numerous commercial and industrial enterprises employ remote devices to acquire relevant data. The acquired data is generally uploaded to a centralized or widely accessible storage resource, where data from many remote devices can be accessed and analyzed.

In fleet management applications, on-board diagnostic (OBD) data capture devices may be located in or on a motor vehicle of an entity that has significant motor vehicle assets and significant transportation costs to monitor and report any number of engine and vehicle parameters. Such devices typically lack persistent access, whether wireless or otherwise, to the Internet or any other public or private communication network and may, therefore, be required to upload data and receive firmware and configuration updates through one or more wireless access points encountered as the motor vehicle travels from place to place.

The process by which a remote device gains access to a particular wireless access point may be simplified by using publicly-accessible wireless networks or by configuring each wireless access point with the same password, but security concerns generally prohibit such steps. It is therefore challenging to fully automate the processes by which remotely located devices are initially configured and subsequently updated to ensure a consistent set of firmware across all remote devices and to fully automate the process by which data from remotely located devices is uploaded via wireless access points distributed over a potentially enormous territory.

### BRIEF DESCRIPTION OF THE DRAWINGS

FIG. 1 illustrates a system that supports a self-configuring remote, data acquisition device;

FIG. 2 illustrates elements of the self-configuring device of FIG. 1;

FIG. 3 illustrates exemplary firmware modules in the self-configuring device of FIG. 2;

FIG. 4 illustrates elements of a wireless access point suitable for use in the system of FIG. 1;

FIG. 5 illustrates exemplary firmware modules in the wireless access point of FIG. 4;

FIG. 6 illustrates a database suitable for use in the system of FIG. 1; and

FIG. 7 illustrates the self-configuring device, the wireless access point, and the database interacting.

### DETAILED DESCRIPTION

Subject matter included herein discloses a data network that includes a database, one or more wireless access points, and a plurality of remotely-located data acquisition devices. Each of the data acquisition devices may be configured to automatically connect or “auto-connect” to a wireless access point that is within range by decrypting an encrypted network identifier broadcasted by a wireless access point to obtain network access information. In at least one embodiment, the encrypted network identifier is implemented as an encrypted service set identifier (SSID).

The encrypted network identifier may be generated with an encryption program running on the wireless access point or another computing device that subsequently provides the encrypted network identifier to the wireless access point. In either case, the wireless access point may then broadcast the encrypted network identifier. The encrypted network identifier may be generated by executing an encryption algorithm using a secret key stored in secure storage and one or more pieces of network access information, at least some of which may be required to login to the wireless access point. The network access information may include a password, a unique identifier of the applicable system, and a network address, which may be an IP address or a domain name service (DNS) address of a communication server or a load balancer.

The wireless access point may include firmware, software, hardware logic, or a combination thereof for generating encrypted network access information. After generating the encrypted network access information, the wireless access point may then incorporate a prefix, suffix, or other unencrypted information into the encrypted network access information in accordance with a particular format to form the encrypted network identifier. The encrypted network identifier may be referred to as an encrypted SSID in embodiments that use a WiFi-compliant wireless access point, i.e., a wireless access point that enables and supports a network compliant with any of the IEEE 802.11 standards. The wireless access point may then broadcast the encrypted network identifier and, in this manner, “publish” the information necessary to access the wireless access point, but only to data acquisition devices that can decrypt the information.

Data acquisition devices may recognize an encrypted network identifier based on particular character string within the identifier, e.g., a particular prefix, suffix, or midfix. Data acquisition devices may extract and decrypt encrypted portions of the identifier to retrieve network access information needed to login to the applicable wireless access point. Use of an encrypted network identifier enables a business or other entity to use a single password/address combination for all data acquisition devices and to easily implement a password change across all wireless access points.

Throughout the following discussion, a hyphenated reference numeral refers to a particular instance of an element while an un-hyphenated form of the same reference numeral refers to the element generically or to a plurality of the elements collectively. For example, a first widget 99-1 represents a particular instance of a plurality of widgets 99, any one of which may be referred to generically as a widget 99.

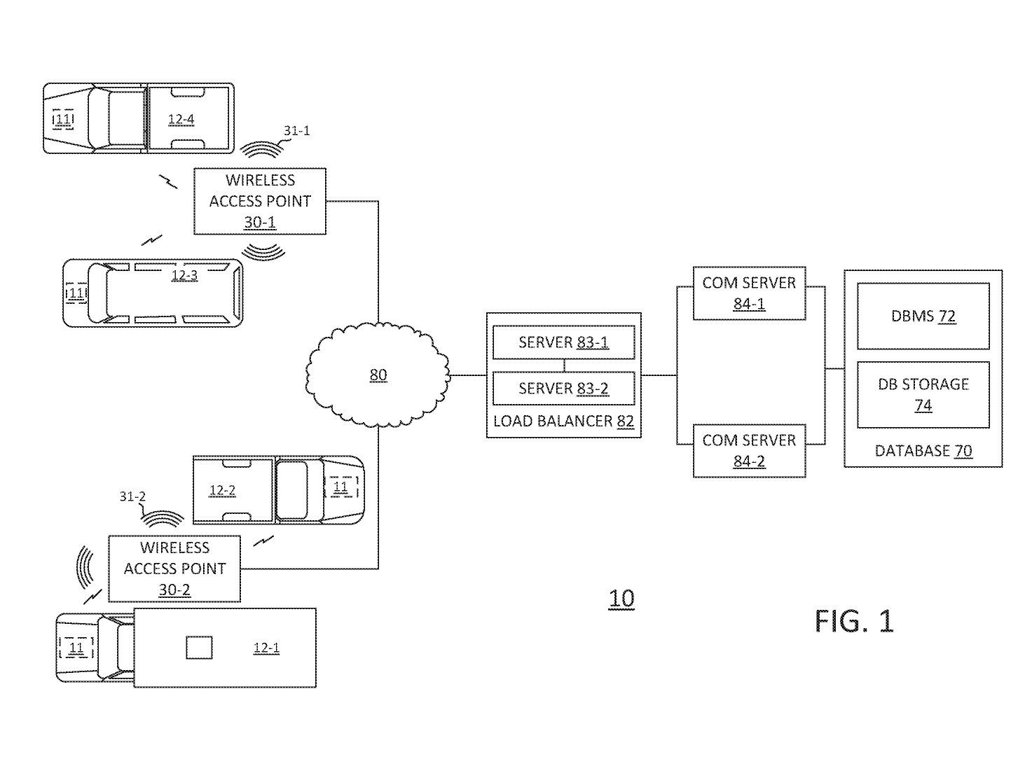

Referring now to the drawings, FIG. 1 illustrates elements of a platform 10 suitable for automatically configuring remote data acquisition devices 11 with configuration information provided by a database 70. While embodiments of platform 10 may include more, fewer, or different, elements than those illustrated in FIG. 1, the platform 10 illustrated in FIG. 1 includes a plurality of wireless access points 30, two of which are depicted explicitly in FIG. 1 as first wireless access point-1 and second wireless access point-2. Each of the wireless access points 30 illustrated in FIG. 1 is coupled to a communication network 80, which may encompass the Internet or another public network, a private network, a virtual private network, or a combination thereof. FIG. 1 illustrates but one configuration of platform 10.

The database 70 illustrated in FIG. 1 is includes a database management system 72 and database storage 74 coupled to communication network 80 through a set of one or more communication servers 84, two of which are depicted in FIG. 1 as communication servers 84-1 and 84-2. A load balancer 82 may be coupled between communication network 80 and communication servers 84. Communication servers 84-1 and 84-2 may comprise different partitions of or different processes executing on a single server. In other embodiments, each communication server 84 may represent a distinct physical server.

In embodiments of platform 10 that employ load balancing, load balancer 82 may distribute database requests from data acquisition devices 11 among the plurality of communication servers 84 to improve the utilization of communication servers 84 and reduce latency associated with requests to access database 70. The load balancer 82 shown in FIG. 1 includes a pair of load balancing servers 83-1 and 83-2 configured as a high-availability server pair to improve reliability, but other embodiments of load balancer 82 may be configured differently.

In at least one embodiment, each of the wireless access points 30 broadcasts an encrypted SSID 31, i.e., an SSID encrypted with network access information that enables data acquisition devices 11 to login to or otherwise utilize the wireless network provided by the wireless access point. Data acquisition devices 11 may include firmware, hardware, or a combination thereof to execute a decryption algorithm to decrypt the encrypted SSID 31 and thereby obtain network access information needed to communicate via the wireless network supported by wireless access point. The network access information may also identify an IP address and a transport layer port number through which the wireless access point 30 may communication with database 70. An event listener (not depicted in FIG. 1) executing on each communication server 84 detects data acquisition devices 11 as they attempt to login. The communication server 84 may receive information from the data acquisition device 11 intended to uniquely identify data acquisition device 11 and communication server may attempt to authorize the data acquisition device with information that may be retrieved from database 70.

A single entity may deploy a plurality of wireless access points 30 over a wide geographic area. Each wireless access point may implement a corresponding wireless network 32 and each wireless access point may broadcast a wireless network identifier 31. Wireless network identifier 31 may include one or more encrypted portions, one or more un-encrypted, or a combination thereof. Each wireless access point 30 may also include a log in module to prevent unauthorized use of the applicable wireless network.

The platform 10 is illustrated in FIG. 1 with a load balancer 82 coupled between communication network 80 and communication servers 84. The load balancer 82 shown in FIG. 1 includes a pair of load balancing servers 83-1 and 83-2 which may be configured as a high availability pair to improve reliability.

In at least one embodiment, each of the communication servers 84 may launch or otherwise execute an event listener that monitors a particular port connection including, in at least one embodiment, an IP address and a port number, of

FIG. 1 illustrates elements of a platform 10 that enable and support self-configuration of remote, data acquisition device 11, which may be referred to herein simply as s self-configuring device 11. In the FIG. 1 illustration of platform 10, self-configuring device 11 communicates with a database 70 through an intermediate wireless access point. The database 70 may be employed for at least two purposes: (1) to store data acquired by and uploaded from self-configuring device 11 and (2) to store information that may be downloaded to self-configuring device 11 and used by self-configuring device 11 to self-configure. In other embodiments, distinct database storage and/or distinct database management systems may be used for these two purposes with one database dedicated to firmware configuration and the other dedicated to uploaded data.

Embodiments of platform 10 may support a fleet management application in which self-configuring device 11 is an OBD data capture device installed in a motor vehicle 12 that is part of an entity's vehicle fleet. For purposes of this disclosure, fleet management may refer to cost and risk management associated with an entity's transportation fleet. Fleet management devices and processes may attempt to reduce costs associated with various transportation parameters including, as non-limiting examples, vehicle telematics (tracking and diagnostics), driver management, speed management, and fuel management. Figures and supporting text included herein may emphasize fleet management embodiments of platform 10 and self-configuring device 11, but the use of an encrypted network identifier to support self-configuring devices is applicable in other applications, including substantially any application in which an entity manages a large number of widely distributed data acquisition devices in the field.

Platform 10 may include an auto-connect feature in which wireless network access information needed by self-configuring device 11 to login to or otherwise gain access to a wireless local area network associated with wireless access point is encrypted and wirelessly broadcasted by wireless access point as an encrypted network identifier. A properly configured self-configuring device 11 may monitor wireless network identifiers periodically, from time to time, or in response to a power reset or another trigger event. The wireless network identifier may comply with formatting protocol that enables self-configuring device 11 to recognize an encrypted network identifier that includes encrypted network access information. Embodiments of platform 10 that employ a WiFi-compliant wireless access point may broadcast the encrypted network access information as a WiFi-compliant SSID or as part of an SSID.

A self-configuring device 11 that has detected an encrypted network identifier may execute a decryption algorithm using a decryption key retrieved from secure storage. The decryption algorithm may parse from the encrypted wireless network identifier, access data that may include an IP or DNS address of wireless access point, a password for wireless access point, and a unique system identifier. The unique system identifier may distinguish different instances of platform 10, different instances of database 70 within a single platform 10, or different groups of wireless access points 30 associated with a common database 70. For example, platform 10 may represent a hosted implementation each of two or more subscribers is represented by a different instance of database 70 and each of the subscribers being associated with a corresponding wireless network identifier.

RF module 16 may enable self-configuring device 11 to communicate with an external device (not depicted) over a wireless local area network 19. Wireless local area network 19 may comply with a WiFi standard, an IEEE 802.15 standard, including Bluetooth or ZigBee, another type of open or proprietary local wireless standard, or a combination thereof.

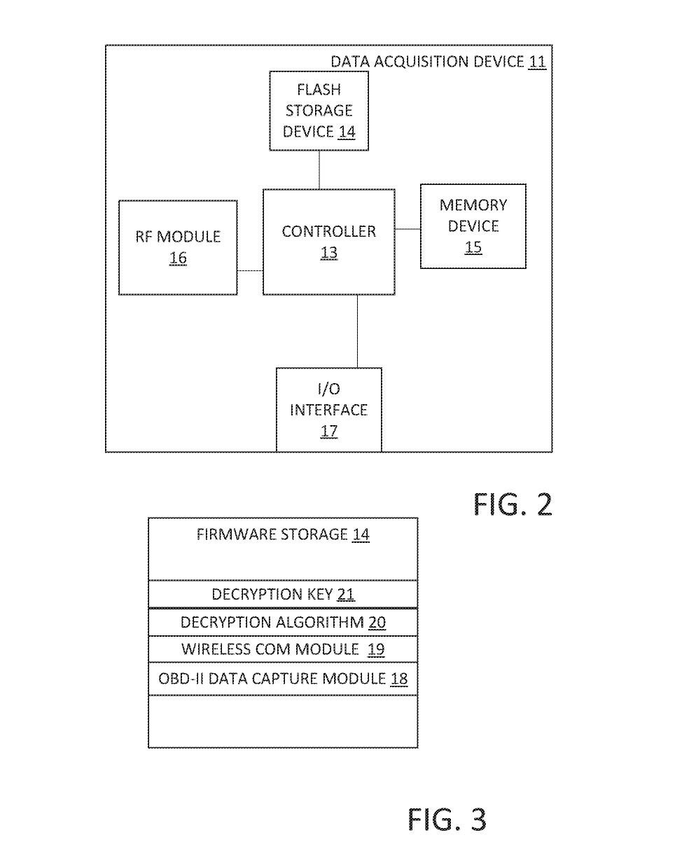

FIG. 2 and FIG. 3 illustrate selected elements of an self-configuring device 11 suitable for use in a fleet management application of platform 10. The self-configuring device 11 illustrated in FIG. 2 includes a controller 13 coupled, either directly or indirectly to various elements of FIG. 2 including a flash storage device 14, a memory device 15, a radio frequency (RF) module 16, and an I/O interface 17. FIG. 3 illustrates selected firmware elements stored in flash storage device 14, including an OBD-II data capture module 18, a wireless communication module 19, and a decryption module 20 and a decryption key 21 that may be used by decryption module 20 to decrypt the encrypted network identifier and establish a wireless communication link with wireless access point. Self-configuring device 11 may further include one or more analog or digital inputs and one or more analog or digital outputs (not depicted) associated with OBD-II data capture functionality. I/O interface 17 may be configured to receive a first end of diagnostic cable that includes a second end configured to connect to an OBD-II port within motor vehicle 12.

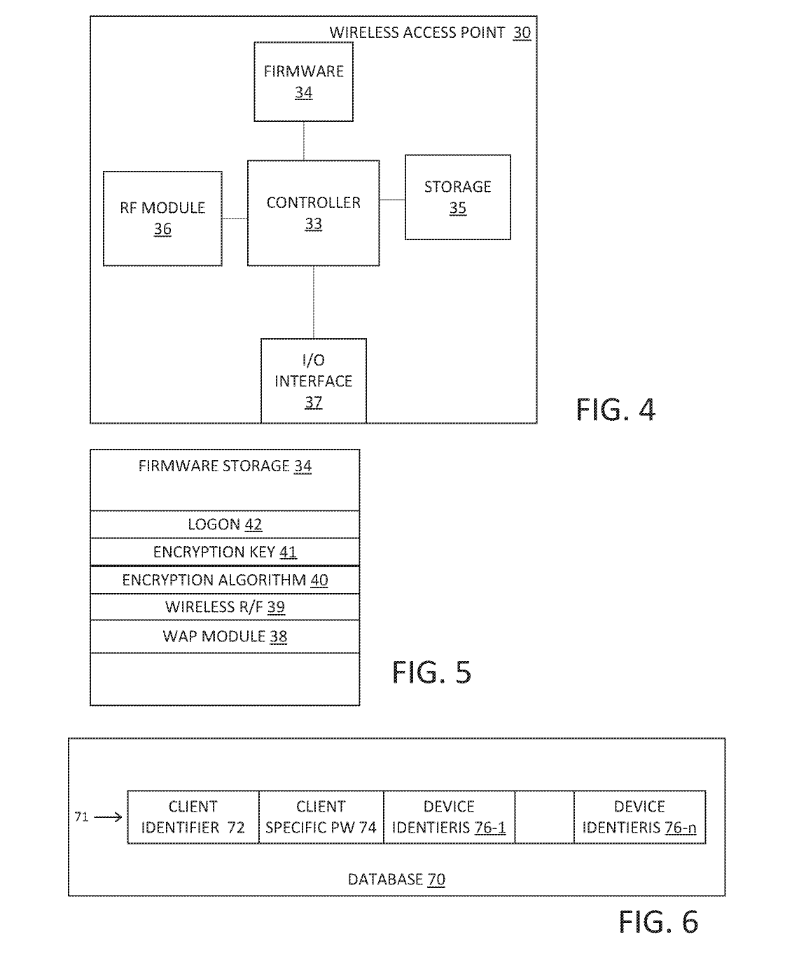

FIG. 4 and FIG. 5 illustrate selected elements of a wireless access point suitable for use in a fleet management application of platform 10. The wireless access point illustrated in FIG. 4 includes a controller 31 coupled, either directly or indirectly, to a flash storage device 34, a memory device 35, a radio frequency (RF) module 36, and an I/O interface 37. FIG. 5 illustrates selected elements of flash storage device 34 that includes wireless access point module 38, wireless communication module 39, an encryption module 40 and a corresponding encryption key 41, and a login module 42.

Encryption module 40 may retrieve or receive one or more pieces of network access information from database 70 via communication servers 84, and one or more pieces of network access information from its own registers. Encryption module 40 may then perform an encryption algorithm on the network access information to generate encrypted network access information. In at least one embodiment, a prefix, suffix, or another type of one or more unencrypted character strings may be added to or otherwise incorporated into the encrypted network access information. In any of these embodiments, the un-encrypted characters may distinguish encrypted network identifiers from conventional wireless network identifiers. For example, embodiments may add a particular string of 3 characters at the beginning, ending, or any intermediate position of the encrypted network access information to distinguish encrypted network identifiers from conventional wireless network identifiers.

The wireless access module 39 may wirelessly broadcast the encrypted network identifier as a WiFi SSID or another type of wireless network identifier. In at least one embodiment, the information that is encrypted into the encrypted character string includes at least some information needed to log into the wireless local area network and communicate with other devices via the wireless local area network.

FIG. 6 illustrates selected elements of a database 70. In at least one embodiment, database 70 includes information, collectively referred to herein as client configuration data 71. The client configuration data 71 illustrated in FIG. 6 includes a client identifier 72, a client-specific password 74, and a plurality of device identifiers 76-1 through 76-n, where each device identifier 76 uniquely identifies a corresponding instance of self-configuring device 11 or another type of remote data acquisition device. Although FIG. 6 depicts a single instance of client configuration data 71 in database 70, other embodiments, including embodiments in which database 70 supports multiple clients, may include multiple instances of client configuration data 71, one instance for each supported entity. The database 70 illustrated in FIG. 6 may be configured to provide client configuration data 71 to one or more instances of wireless access points 30 via a communication network 80, which may refer to data communication network that encompasses the Internet, another public network, one or more private networks, one or more virtual private networks (VPNs), or a combination thereof.

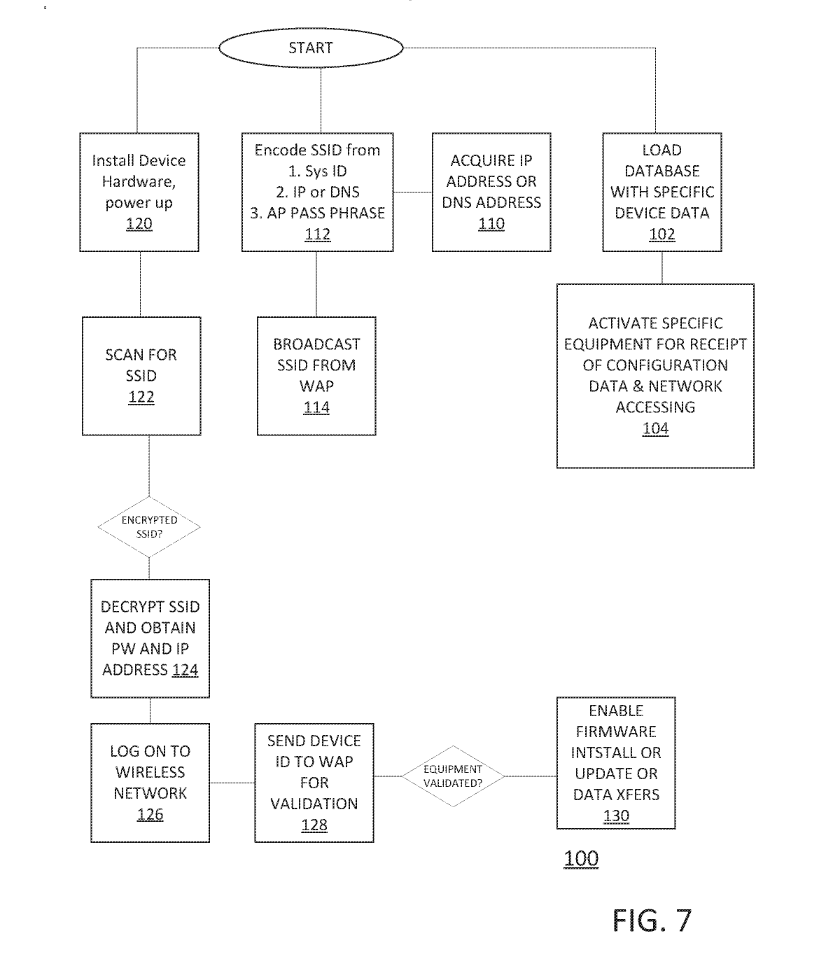

FIG. 7 illustrates a method 100 by which a self-configuring device, a wireless access point, and a database coordinate activity to implement and support fully automated access to the wireless access point. FIG. 7 illustrates method 100 in three columns, the leftmost column corresponding to the self-configuring device, the center column corresponding to the wireless access point, and the right column corresponding to the database server and database.

With respect to the database server in the right-hand column, the method 100 illustrated in FIG. 7 includes block 102, illustrating the loading of specific device data into the database. In the context of a fleet management application in which the specific device may refer to an OBD-II data capture device, the data capture device is generally associated with a specific motor vehicle. In this context, the vehicle identification number (VIN) of the applicable motor vehicle may be used as the specific device data that is loaded into the database. Use of the VIN may be preferable to using a media access control (MAC) address or other form of hardware identifier to prevent situations in which a data acquisition device is removed from one vehicle and installed in another vehicle without authorization. In other embodiments, it may be desirable to verify the VIN number as well as the MAC address of the data acquisition device and, in these applications, block 102 may include loading the database with VIN numbers as well as OBD data capture device MAC address data.

After the database is loaded with specific device data in block 102, the method 100 illustrated in FIG. 7 includes block 104 in which specific devices identified in the database are activated for receipt of configuration data and network access data. In this context, configuration data may refer to configuration settings applicable to the data acquisition functionality of the data devices. In the case of OBD data capture devices, a configuration setting may indicate, as one non-limiting example, the type of OBD interface that is used in the applicable vehicle. Network access data may refer to information required by the data acquisition device to log into or otherwise gain access to a wireless network maintained by the applicable wireless access point. The block 104 depicted in FIG. 7 may include the implementation of a listener application that monitors the applicable IP address and port of a particular wireless access point for a particular data acquisition device attempting to connect to the wireless access point.

In the middle column of the method 100 illustrated in FIG. 7, the wireless access point acquires, in block 110, an IP or DNS address for the communication server or a load balancer that controls access to the database server. The wireless access point may then generate an encrypted SSID using a secret key stored in secure access of the wireless access point. In block 112, the wireless access point encrypts three pieces of information into the encrypted SSID. Specifically, the illustrated example of block 112 encodes, along with the IP or DNS acquired in block 110, an access point password as well as a unique system identifier.

After generating the encrypted SSID, the method 100 depicted in FIG. 7 illustrates the wireless access point broadcasting, at block 114, the encrypted SSID. The broadcasting of the encrypted SSID may be specific to an embodiment in which the wireless access point complies with a WiFi standard. In other embodiments, the wireless access point may enable and support a Bluetooth network, a Zigbee network, or another wireless protocol and the wireless access point may broadcast a different piece of information to convey the necessary network access information. For example, in a Bluetooth application, the wireless access point may encrypt and broadcast wireless access point network access information through a pairing code or other suitable mechanism.

FIG. 7 illustrates the self-configuring device, in the left column, being installed in a vehicle and powered up at block 120. In applications pertaining to fleet management, the self-configuring device may include, in at least one embodiment, OBD data capture features and functionality analogous to a W4 CANceiver device from E. J. Ward, Inc., which integrates OBD-II data acquisition functionality with fuel management control, vehicle and driver behavior monitoring and data retrieval, and passive GPS. In block 122, the self-configuring device scans for broadcasted SSIDs. If the self-configuring device detects a wireless network identifier that has a format compatible with an encrypted network identifier, self-configuring device will decrypt, in block 124, the encrypted network identifier and thereby obtain a password and an IP address of the database server. The self-configuring device may then initiate a logon to the wireless via the wireless access point in block 126.

The method 100 illustrated in FIG. 7 includes a validation block 128 in which the self-configuring device provides its own device identifier to the wireless access point and the wireless access point compares the identifier for the self-configuring device to a plurality of device identifiers stored in database 70. If the self-configuring device is validated, firmware or firmware updates or other executable instructions may be provided to the self-configuring device in block 130 and data acquired by the self-configuring device may be transferred to the database server.

What is claimed is:

1. A data acquisition system, comprising:
a database server coupled to a database;
a wireless access point coupled to the database server;
a remote data acquisition device;
wherein:
the database server is configured to provide a network password and a network address to the wireless access point;
the wireless access point is configured to broadcast an encrypted network identifier, indicative of the network password and the network address; and
the self-configuring device is configured to:
decrypt the encrypted network identifier to obtain the network password and network identifier;
login to the wireless access point; and
obtain, from the network address, configuration data.

2. The data acquisition system of claim 1, wherein the wireless access point is coupled to the database server through an intervening communication server and load balancer.

3. The data acquisition system of claim 1, wherein the wireless access point is configured to:
generate encrypted network access information in accordance with the network access information, a particular encryption algorithm, and a secret key stored in secure storage of the wireless access point;
generate an encrypted network identifier by including un-encrypted information into the encrypted network access information according to a particular format; and
wirelessly broadcast the encrypted network identifier.

4. The data acquisition system of claim 3, wherein the self-configuring device is configured to distinguish the encrypted network identifier from other network identifiers by recognizing the unencrypted information in the particular format.

5. The data acquisition system of claim 1, wherein:
the database server is configured to store a plurality of data acquisition device identifiers in the database;
the self-configuring device is configured to provide a particular data acquisition device identifier to the wireless access point; and
the wireless access point is configured to validate the particular device identifier as one of the plurality of device identifiers.

6. The data acquisition system of claim 5, wherein each of the data acquisition devices is associated with a motor vehicle and wherein each of the plurality of device identifiers comprises a corresponding vehicle identification number.

7. The data acquisition system of claim 5, each of the plurality of device identifiers comprises a media access control address.

8. The data acquisition system of claim 1, wherein the encrypted network identifier comprises a secure set identifier of an 802.11 network enabled and supported by the wireless access point.

9. A self-configuring data acquisition device, comprising:
a controller;
a radio frequency module;
an I/O interface; and
computer executable instructions which, when executed, cause the controller to perform operations comprising:
decrypting an encrypted network identifier broadcasted by a wireless access point to obtain network access information;
connecting to a wireless local area network provided by the wireless access point; and
accessing a database server at a network address included in the network access information to request at least one of: a firmware update and a configuration setting.

10. The self-configuring device of claim 9, wherein the operations include:
recognizing the encrypted network identifier based on a formatting of unencrypted portions of the encrypted network identifier.

11. The self-configuring device of claim 9, wherein the wireless local area network comprises WiFi network

12. The self-configuring device of claim 9, wherein the wireless local area network comprises an IEEE 802.15 compliant network.

13. The self-configuring device of claim 9, wherein the operations include:
providing a device identifier to the wireless access point.

14. The self-configuring device of claim 13, wherein the self-configuring device is located on a motor vehicle and wherein the device identifier comprises a vehicle identification number of the motor vehicle.

15. A wireless access point, comprising:
a controller;
a radio frequency module to provide a wireless local area network;
computer readable storage including executable instructions that, when executed comprise:
receiving network access information from a database server;
generating an encrypted network identifier network based on the network access information; and
broadcasting the encrypted network identifier.

16. The wireless access point of claim 15, wherein the wireless local area network comprises an IEEE 802.11 network;

17. The wireless access point of claim 15, wherein the network access information includes a password and a network address.

18. The wireless access point of claim 15, wherein the operations include:
receiving, from a data acquisition device, a particular device identifier; and
receiving, from the database server, a plurality of device identifiers.

19. The wireless access point of claim 15, wherein the operations include: validating the data acquisition device responsive to detecting the particular device identifier within the plurality of device identifiers.
